(19) United States
(12) Patent Application Publication
(10) Pub. No.: US 2014/0006944 A1
(43) Pub. Date: Jan. 2, 2014

(54) Visual UI Guide Triggered by User Actions

(71) Applicants: Aaron Alexander Selig, Mill Valley, CA (US); Darshan Keshavlal Bavaria, Seattle, WA (US)

(72) Inventors: Aaron Alexander Selig, Mill Valley, CA (US); Darshan Keshavlal Bavaria, Seattle, WA (US)

(73) Assignee: MICROSOFT CORPORATION, Redmond, WA (US)

(21) Appl. No.: 13/539,849

(22) Filed: Jul. 2, 2012

(51) Int. Cl. G06F 3/048; G06F 3/041

(52) U.S. Cl. 715/705

(57) ABSTRACT

A visual help user interface (UI) to help a user learn a product's capability and inputs needed to achieve a given action is provided. The visual help (UI) may be launched via a trigger and may overlay a software application with a graphical user interface (GUI). A trigger may include detection of a user action associated with a given action in an application, receiving a command sequence associated with the given action, or receiving a request for help by a user. The visual help UI may be utilized to demonstrate a feature, to suggest or demonstrate a work flow, or to teach a gesture. The visual help UI may be animated to imply interaction and may demonstrate a suggested workflow or input sequence using a user's content in the application GUI.

### BACKGROUND

Oftentimes, a user may want or need help discovering features or capabilities associated with an application. For example, a user may need assistance knowing what input is needed or a shortcut to accomplish a task within the application, such as checking off items in a to-do list.

A current method for helping users to discover features includes help articles that may include text and images. A limitation to this approach is that when viewing a help article, a user is not in the context an application and may not know how actions described in the article may be executing with his content. In addition, the user may have to manage two contexts at once—the help article user interface pane and the application user interface pane. With the increased use of mobile computing devices such as smart phones and tablet computing devices, screen space may be limited and, in some cases, the device may be unable to show multiple application panes at once. Additionally, describing or explaining gestures or action sequences via a help article can be difficult.

It is with respect to these and other considerations that the present invention has been made.

### SUMMARY

Embodiments of the present invention solve the above and other problems by providing a visual guidance user interface to help a user learn a product's capability and inputs needed to achieve a given action.

According to embodiments, a visual help user interface (UI) may be launched via a trigger and may overlay a software application with a graphical user interface (GUI). The visual help UI may be utilized to demonstrate a feature (e.g., a gesture, functionality, behavior, etc.), to suggest or demonstrate a work flow (e.g., how to create a to-do list), or may teach a gesture (e.g., demonstrate a gesture or correct an unrecognized gesture). The visual help UI may be animated to imply interaction and may demonstrate a suggested workflow or input sequence using a user's content in the application GUI.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

The accompanying drawings, which are incorporated in and constitute a part of this disclosure, illustrate various embodiments of the present invention. In the drawings:

FIG. 1 is an illustration of an example help article in current applications;

FIG. 2 is an illustration of an example visual help UI displayed on a task list application GUI on a mobile phone demonstrating a gesture input;

FIG. 3 is an illustration of a user manually selecting to view a visual help UI through a help or “how-to” article;

FIG. 4 is an illustration of a visual help UI demonstrating a work flow suggestion;

FIGS. 5A-C are illustrations of a visual help UI displayed on a map application on a mobile phone, wherein a compass or gyroscope is utilized to sense orientation of a device;

FIGS. 6A and 6B are illustrations of a visual help UI displayed on a camera application on a mobile phone, wherein an accelerometer is utilized to sense motion;

FIGS. 7A and 7B are illustrations of a visual help UI displayed on a notes application on a laptop computer, wherein a microphone is utilized to detect noise;

FIG. 8 is an illustration of a visual help UI displayed on a IP phone, wherein a microphone is utilized to detect noise;

FIG. 9 is a flow chart of a method for providing a visual guidance user interface to help a user learn a product's capability and inputs needed to achieve a given action;

FIG. 10 is a block diagram illustrating example physical components of a computing device with which embodiments of the invention may be practiced;

FIGS. 11A and 11B are simplified block diagrams of a mobile computing device with which embodiments of the present invention may be practiced; and

FIG. 12 is a simplified block diagram of a distributed computing system in which embodiments of the present invention may be practiced.

### DETAILED DESCRIPTION

As briefly described above, embodiments of the present invention are directed to providing a visual guidance user interface to help a user learn a product's capability and inputs needed to achieve a given action. Embodiments may be utilized to aid a user in discovering or learning about an application by demonstrating possible workflows or input sequences for a given action within the application. Embodiments do not require additional application user interface panes and may be launched via a smart trigger, via interaction with a user's content, and/or via a selection by a user to demonstrate a work flow or input sequence to complete a task.

The following detailed description refers to the accompanying drawings. Wherever possible, the same reference numbers are used in the drawing and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention, but instead, the proper scope of the invention is defined by the appended claims.

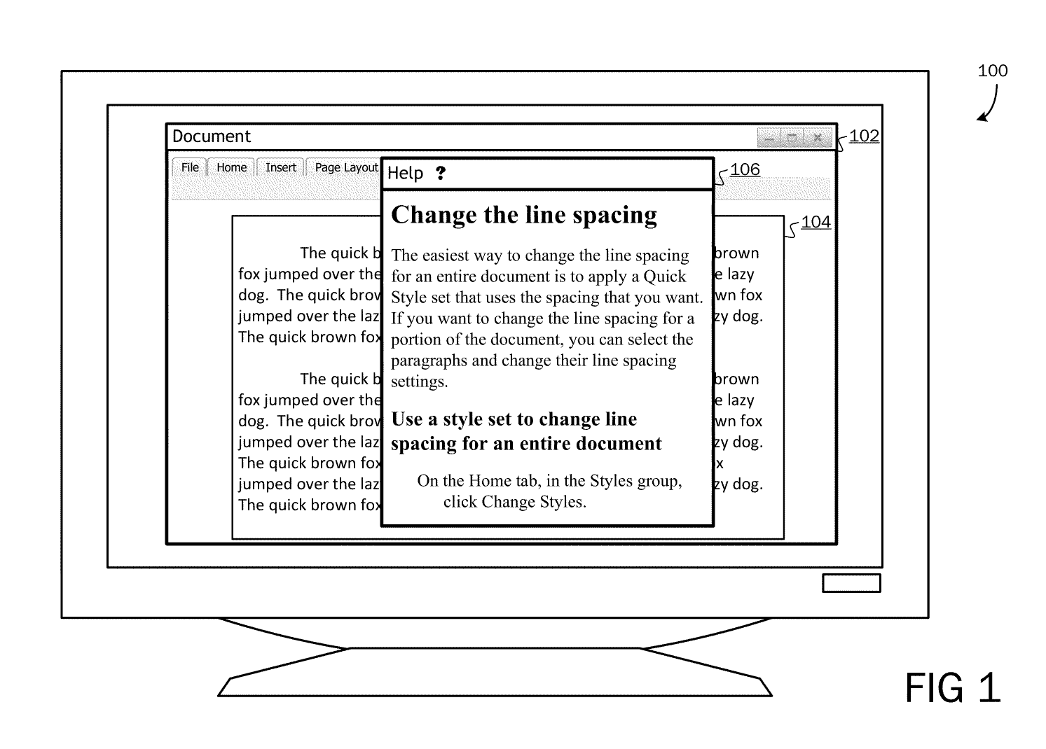

Referring now to the drawings, in which like numerals represent like elements, various embodiments will be described. As previously described above, and as shown in an example display 100 illustrated in FIG. 1, a current help tool solution may include a help article 106. Oftentimes, as illustrated, when utilizing a help article 106 for an application, the help article 106 may be displayed in a user interface pane separate from the application user interface pane 102, which may require the user to manage two contexts at once. Also, when utilizing a computing device with less screen space (e.g., a mobile phone or a tablet device), multiple application user interface panes may not be opened at the same time. This, in addition to the method of instruction available in the help article 106 being in text and images, may make it difficult for a user to discover or understand a product's features.

Embodiments of the present invention comprise a visual help user interface (UI) that may overlay a software application with a graphical user interface (GUI) and may be launched via various triggers. According to an embodiment, a visual help UI may be utilized for a feature discovery (e.g., a gesture, functionality, behavior, etc.), and may be triggered manually by a user or automatically. A user may select to view a visual help UI for a particular task or feature or alternatively, a visual help UI may be triggered automatically. For example, a determination may be made that a user is going through extra steps to complete a task that could be accomplished via a shortcut or via a method involving less steps. As another example, a visual help UI may be displayed after a predetermined time period has elapsed without user input.

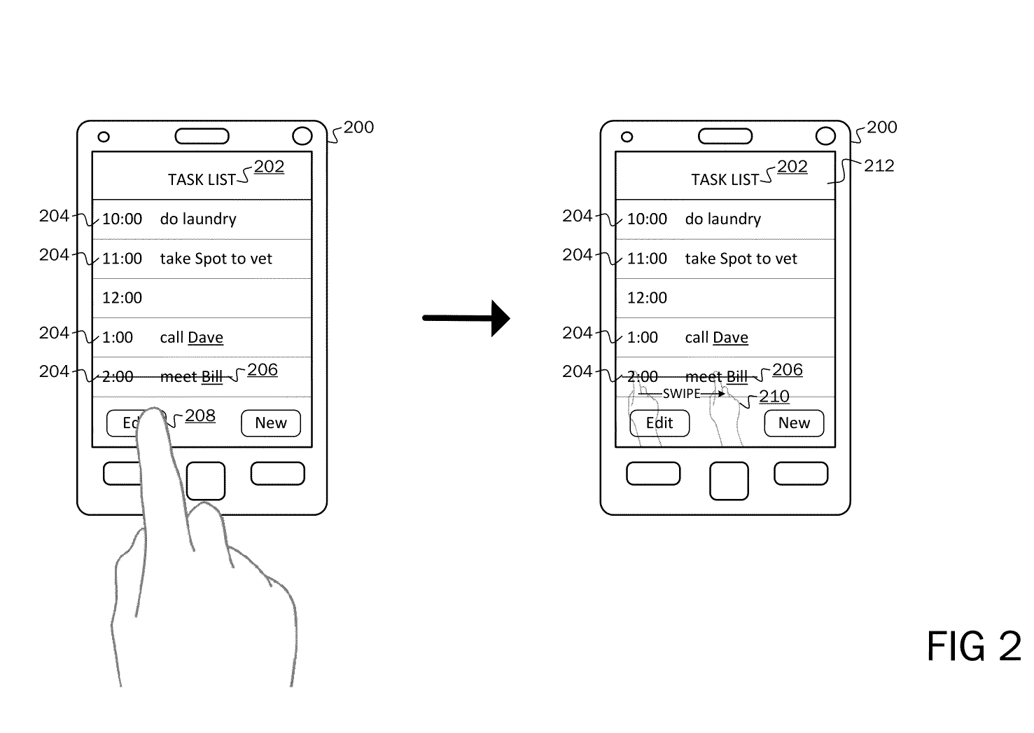

As illustrated in FIG. 2, a user may utilize a task list application 202 on a mobile computing device 200. The user may want to mark 206 an item 204 as completed. The user may go through a menu, such as selecting an edit function 208 to utilize a functionality to mark 206 through an item 204. The user may be unaware that the task list application 202 has a feature that allows the user to use his finger to swipe across an item 204 to mark 206 it as complete. According to embodiments, a visual help UI, such as a ghost hand 210, may be triggered and displayed on the task list application 202 GUI 212 and may demonstrate an input, such as a gesture input, that can be utilized to accomplish a task. A gesture input may include an input made without a mechanical device (e.g., a user body movement) or with a mechanical input device (e.g., with a mouse, touchscreen, stylus, etc.), the input originating from a bodily motion that can be received, recognized, and translated into a selection and/or movement of an element or object on a graphical user interface that mimics the bodily motion.

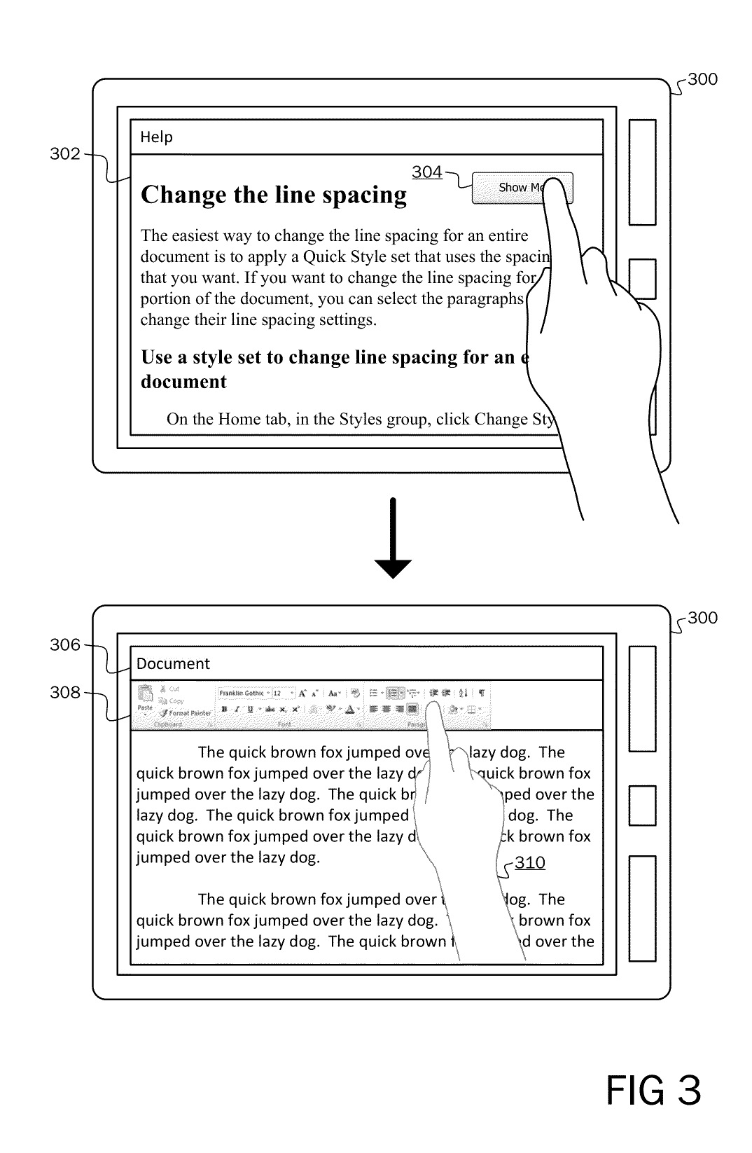

According to another embodiment, a visual help UI may be utilized for a work flow suggestion. A work flow suggestion may be triggered manually or may be triggered automatically by user action. For example, a user may manually select to view a visual help UI through a help or “how-to” article 302 as illustrated in FIG. 3. As illustrated, a help article 302 which may contain instructions on how to complete a task is displayed on a tablet computing device 300. A control, such as a “show me” button 304 may be provided, which when selected, may launch a visual help UI (i.e., demonstration) showing a sequence of inputs to accomplish a task as detailed in the help article 302. For example, the demonstration may include a ghost hand 310 selecting controls in a toolbar 308 of an application user interface pane 306 to accomplish a task, for example, changing the line spacing in a document.

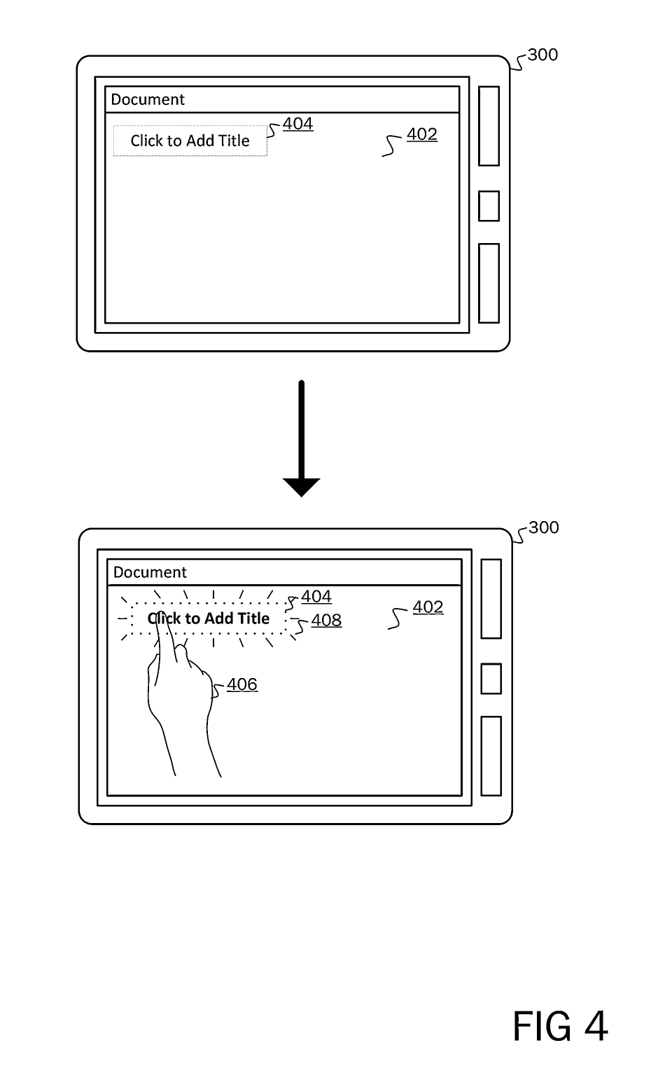

As mentioned above, a visual help UI demonstrating a work flow suggestion may be triggered automatically. For example, a user may open an application and create a new document 402 as illustrated in FIG. 4. If the user hesitates before performing a next action, for example, a predetermined time period elapses before a subsequent action (e.g., clicking an “add title” control 404) is detected, a visual help UI may be provided. For example, a ghosted animation 406 selecting a control (e.g., “add title” control 404) may be displayed or the control may be highlighted 408 or may flash to show the user that selecting the control 404 is a suggested next step.

According to another embodiment, a visual help UI may be triggered manually or automatically to teach or demonstrate or a gesture that can be utilized in an application. For example, a visual help UI, such as a floating hand or an arrow, may be displayed over an application GUI, such as a task list application GUI, and may demonstrate a gesture that may be utilized to interact with an element of the application (e.g., the floating hand dragging a task item down a list to demonstrate that task items can be reordered). According to an embodiment, a visual help UI may provide gesture feedback. For example, a determination may be made that a user is inputting a gesture that is not a recognized gesture but is identified as being close to a recognized gesture. A visual help UI may be displayed showing the user the recognized gesture. Consider, for example, a user is using a diagonal swiping motion through a task item in a task list application. A determination may be made that the user may be trying to mark through the task list item, and a visual help UI may be displayed showing a horizontal swiping motion through the task item and showing the item being marked as complete. According to embodiments, a sensitivity level of triggering a visual help UI may be adjustable. For example, a visual help UI may be displayed upon a determination of any incorrect gesture, may be displayed automatically upon detecting an input of an unrecognized gesture after a predetermined number of times, may be displayed once, or may be displayed a predetermined number of times. According to an embodiment, a visual help UI may be a feature that may be toggled on or off.

Embodiments of the present invention may be applied to various software applications and may be utilized with various input methods. Although the examples illustrated in the figures show touch based UIs on mobile 200 and tablet 300 devices, embodiments may be utilized on a vast array of devices including, but not limited to, desktop computer systems, wired and wireless computing systems, mobile computing systems (e.g., mobile telephones, netbooks, tablet or slate type computers, notebook computers, and laptop computers), hand-held devices, IP telephones, gaming devices, cameras, multiprocessor systems, microprocessor-based or programmable consumer electronics, minicomputers, and mainframe computers. A visual help UI may include, but is not restricted to, an arrow or focus indicator, a ghosted hand, finger, or stylus, an animated figure or avatar, highlighting, audio, or an indication of a touch or a selection. Visuals may be animated to imply interaction or emphasis and may manipulate or show a suggested workflow or input sequence using a user's actual content.

According to embodiments a visual help UI may be activated by various triggers including, but not limited to, a user action detected by a device or sensor, a selection of a control or command sequence, or an explicit request by a user. A trigger activated by a device or sensor may include various types of sensors including, but not limited to, a digitizer, a gyroscope, a compass, an accelerometer, a microphone, a light sensor, a proximity sensor, a near field communications (NFC) sensor, a GPS, etc.

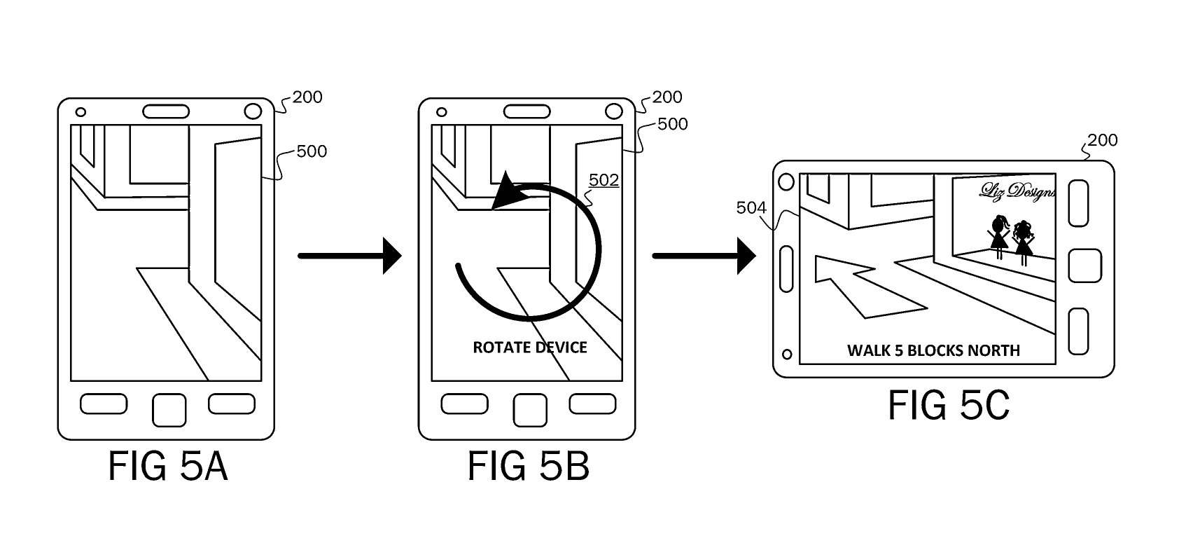

A digitizer is an electronic component that may be utilized to receive input via sensing a touch of a human finger, stylus, or other input device on a touch screen interface. A digitizer, for example, may be utilized to sense when a user makes or repeats an unrecognized gesture on a screen. A compass or gyroscope, for example, may be utilized to sense orientation of a device, navigation, etc. For example, and as illustrated in FIGS. 5A-C, a user may utilize a mobile phone 200 or a GPS device for a map or GPS application (e.g., an augmented reality application). A user may be holding the device 200 so that a map is displayed in a portrait orientation 500 as illustrated in FIG. 5A, which may not be an ideal orientation for utilization of the application. A compass or gyroscope may be utilized to sense the orientation of the device 200 and, as illustrated in FIG. 5B, a visual help UI, such as a rotation arrow 502 and/or text, may be displayed on the map interface to suggest to the user to rotate the device 200. The user may turn the device 200 as illustrated in FIG. 5C, wherein the map may be displayed in a landscape orientation 504, providing a better display for utilization of the application.

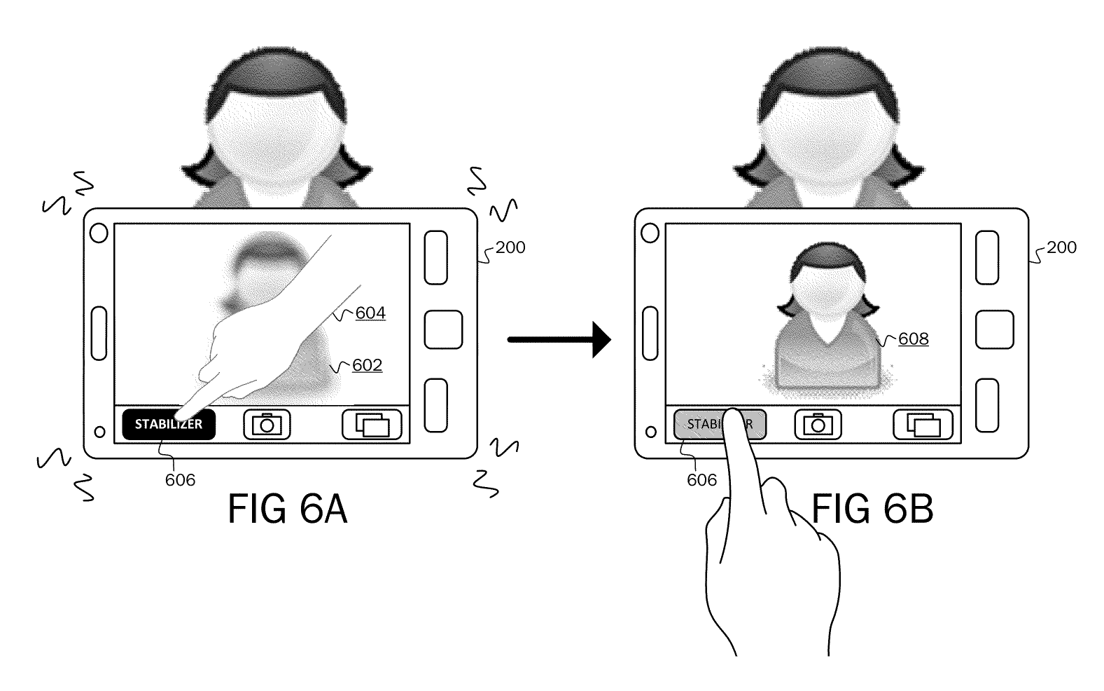

An accelerometer, for example, may be utilized to detect movement or stability of a device. As an example, an accelerometer may be utilized to detect that a device is not stable and may be being used in a car or in a bus. Embodiments may provide a visual help UI to suggest to the user to use voice input and may show the user where to click to initiate the voice input. As another example, and as illustrated in FIGS. 6A and 6B, a user may utilize a mobile phone 200, a camera, or other type of device for taking a picture. An accelerometer on the device 200 may be utilized to detect that the device 200 is not being held steadily, resulting in a blurred photograph 602. A visual help UI, such as a ghosted hand 604 displayed on the GUI, may be provided demonstrating to the user that a stabilization function 606 may be utilized to take a better photograph. The user may choose to select the stabilization function 606 as shown in FIG. 6B, resulting in a better output 608 for the camera application functionality.

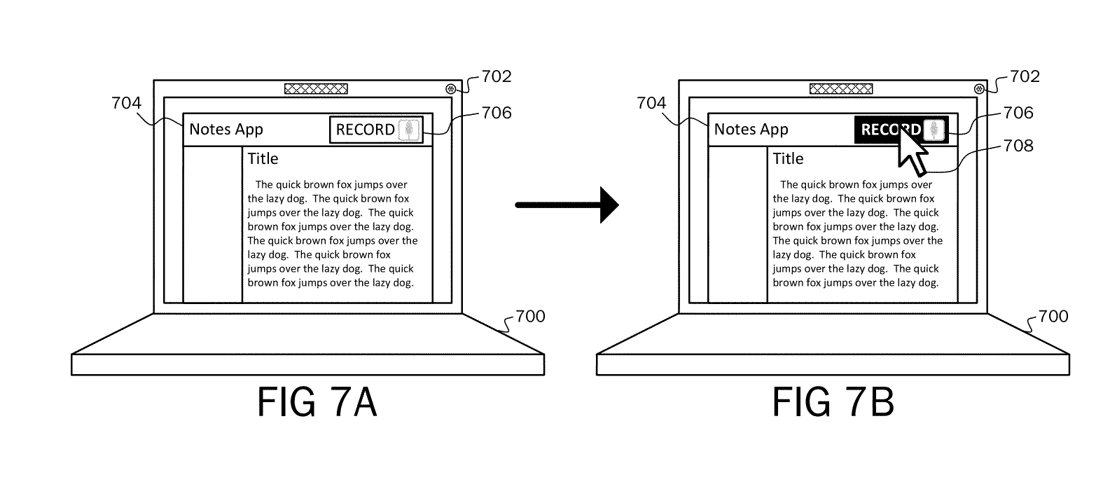

A microphone, for example, may be utilized to detect audio. As an example and as illustrated in FIGS. 7A and 7B, a microphone 702 on a device, such as a laptop computer 700 running an application such as a notes application 704, may be utilized to detect noise, such as a voice in the environment. A detection of a voice may trigger a visual help UI, for example, a mouse pointer 708 displayed selecting a record audio functionality 706.

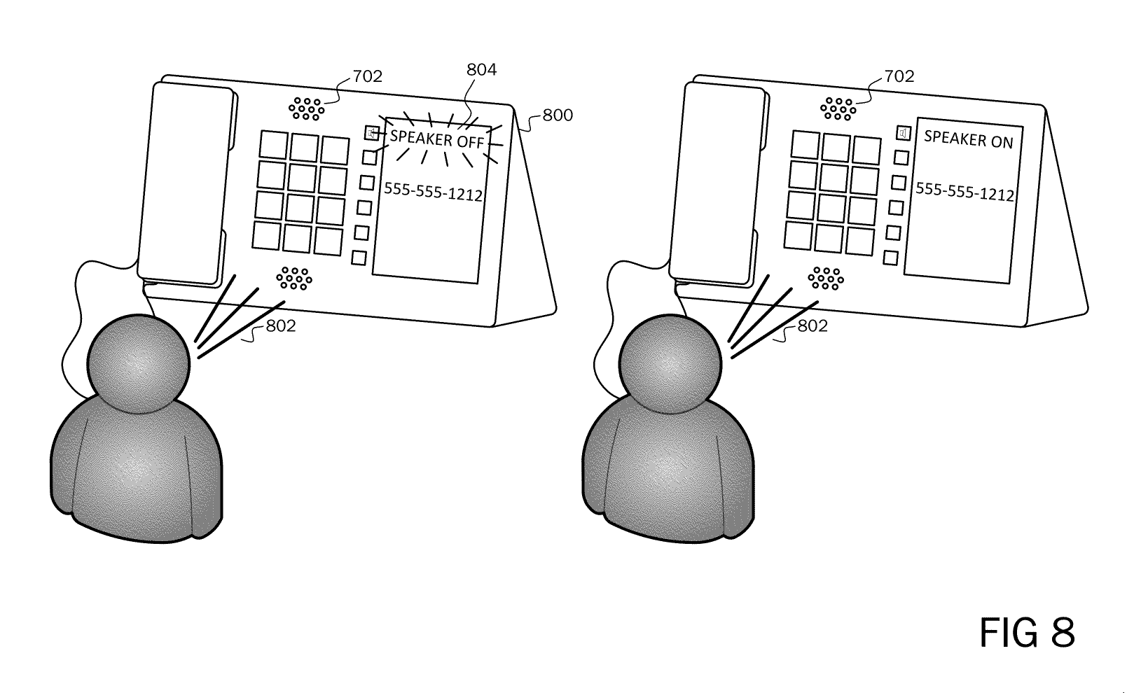

As another example of a microphone being utilized to trigger a visual help UI and as illustrated in FIG. 8, a microphone 702 on a device, such as an IP telephone 800, may be utilized to detect noise, such as a user speaking into the microphone while on a conference call while the telephone is on mute. Embodiments may detect that the user is talking 802 into the telephone 800 while the telephone is on mute and may suggest to the user via a visual help UI, for example, a visual notification 804 that the telephone is on mute, to unmute the telephone.

A light sensor, for example, may be utilized to detect if a functionality such as a flash on a camera or a speakerphone on a mobile phone should be used while a user is utilizing the device for a certain application. As an example, a light sensor on a mobile phone 200 may detect that, while a user is using a camera application, the amount of light may produce an underdeveloped photograph. This detection may trigger a visual help UI to suggest turning on a flash on the device 200.

A GPS may be utilized to detect that a user is travelling and trigger a visual help UI. For example, a GPS may detect that a user is driving while the user has an application open, for example, a food finder application, on his mobile phone 200. A visual help UI may be triggered to suggest using a “local feature” on the application to find nearby restaurants.

A proximity sensor may be utilized to detect a distance between a device and another object (e.g., the distance between a mobile phone 200 and a user's face). For example, a user may use a front-facing camera on a mobile phone 200 to chat with someone. A proximity sensor may be used to detect if the phone is being held too closely to the user's face. A visual help UI may be triggered to suggest holding the phone 200 further away.

A near field communications (NFC) sensor may be utilized to detect other NFC-capable devices and may also be utilized to facilitate an exchange of data between NFC-capable devices. For example, a user may use a mobile phone 200 to pay for a cup of coffee at a coffee shop. An NFC sensor may be used to detect if a user does not hold his phone 200 over a payment sensor long enough for a transaction to complete. A visual help UI may be triggered to inform the user to hold his phone over the payment sensor longer or may warn the user that the transaction has not completed.

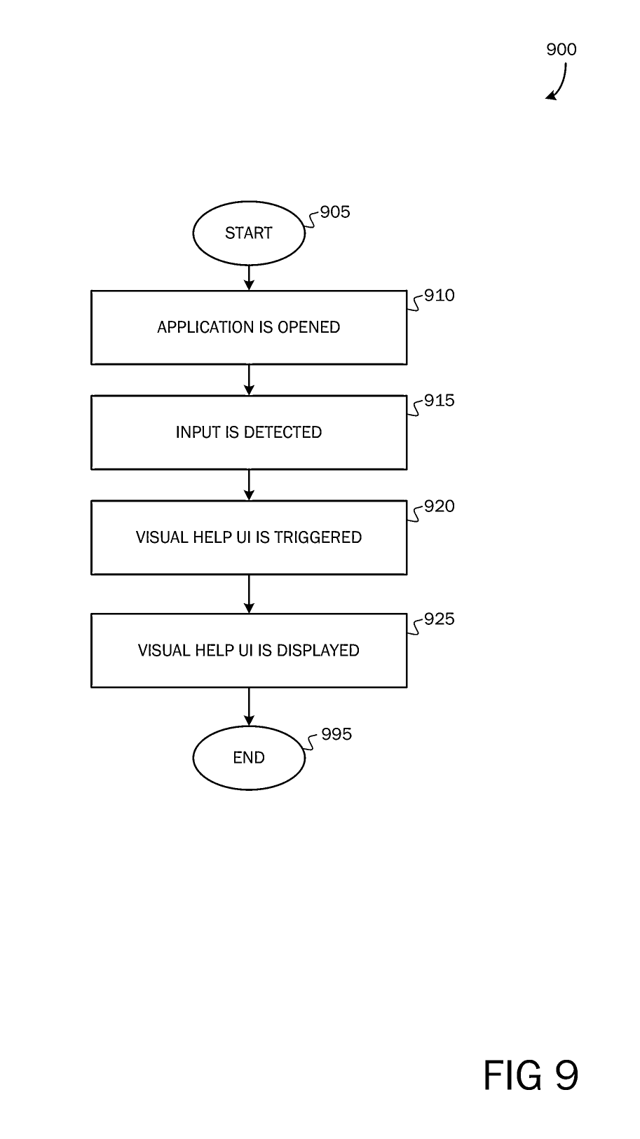

Referring now to FIG. 9, a flow chart of a method 900 for providing a visual guidance user interface for helping a user learn a product's capability and inputs needed to achieve a given action is illustrated. The method 900 starts at OPERATION 905 and proceeds to OPERATION 910 where an application is opened. The application may be one of various types of applications with a graphical user interface.

At OPERATION 915, an input is received. For example, as described above with reference to FIGS. 2-8, an input may include a user action detected by a device or a sensor on a device, a selection of a button, functionality, or command sequence on a device, or may be a request by a user for help. A user action detected by a device may include, but is not limited to, a digitizer sensing a gesture made on the device, a gyroscope or compass sensing an orientation of the device, an accelerometer sensing motion of the device, a microphone sensing noise, a light sensor sensing light, a proximity sensor sensing proximity of a user to the device, a near field communications (NFC) sensor detecting other NFC-capable devices and facilitating an exchange of data between devices, or a GPS sensing a position of the device. As described above, a gesture input may include an input made without a mechanical device (e.g., a user body movement) or with a mechanical input device (e.g., with a mouse, touchscreen, stylus, etc.), the input originating from a bodily motion that can be received, recognized, and translated into a selection and/or movement of an element or object on a graphical user interface that mimics the bodily motion. A selection of a button, functionality, or command sequence on a device may include, for example, a detection of a sequence of commands a user enters to accomplish a task or a hesitation or elapse of a threshold of time after opening an application or after completing a task. A request by a user for help may include, but is not limited to, a selection of a “show me” button 304 in a help or “how-to” article 302 as illustrated in FIG. 3, selecting a “help” functionality command, or a selection of a “turn help tips on” feature in a settings or help menu.

The method 900 proceeds to OPERATION 920, where a determination is made whether the input received in OPERATION 915 meets a criterion for triggering a visual help UI. In response to determining that the input meets a criterion for triggering a visual help UI, at OPERATION 925, the visual help UI is displayed. According to embodiments, the visual help UI may be displayed over the application GUI and may demonstrate a feature, workflow, or gesture using the current application being utilized and using the user's content. For example, the visual help UI may demonstrate a feature on a device, such as a gesture, functionality, or behavior. The visual help UI may suggest a work flow, for example, how to create a to-do list or a suggested next step after a pause or hesitation is detected at OPERATION 915. The visual help UI may teach a gesture language. For example, a gesture such as a swipe across a task item in a to-do list may be demonstrated. As another example, if at OPERATION 915, a digitizer on a device detects that a user is using a gesture that is not recognized, at OPERATION 925, a demonstration of a gesture that may be determined as a recognized gesture similar to the gesture made by the user may be displayed.

As described above, the visual help UI may include, but is not restricted to, an arrow or focus indicator, a ghosted hand, finger, or stylus, an animated figure or avatar, highlighting, audio, or an indication of a touch or a selection. Visuals may be animated to imply interaction or emphasis and may manipulate or show a suggested workflow or input sequence using a user's actual content. The method ends at OPERATION 995.

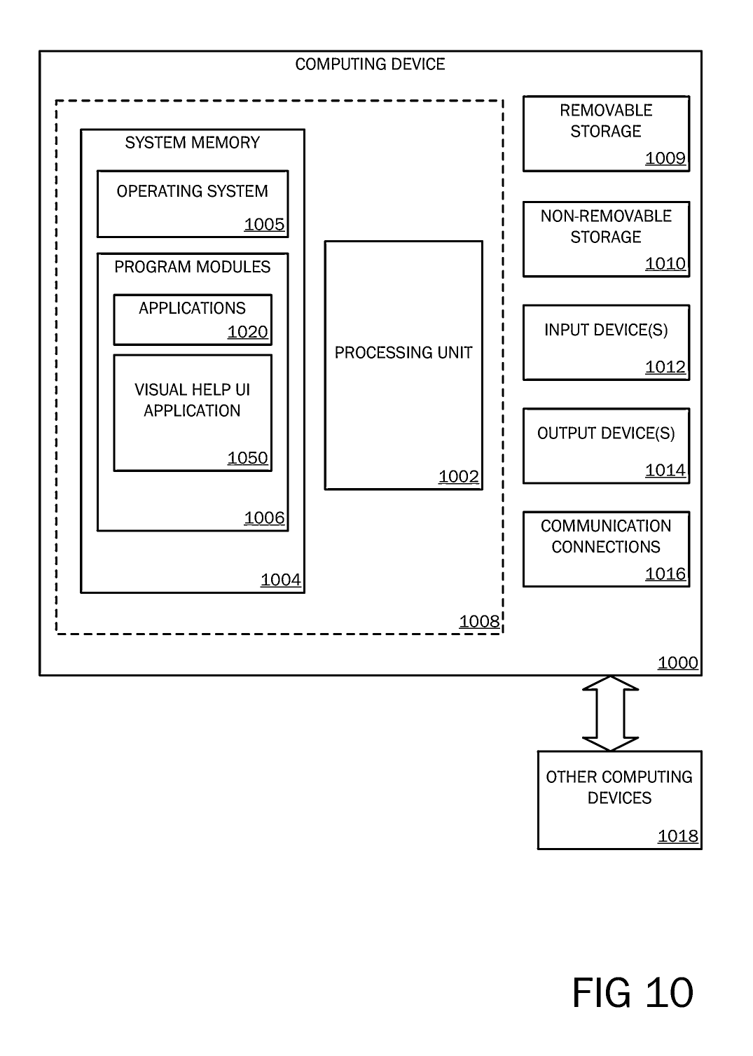

The embodiments and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, IP phones, gaming devices, multiprocessor systems, microprocessor-based or programmable consumer electronics, minicomputers, and mainframe computers. In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like. As described above, gesture entry may also include an input made with a mechanical input device (e.g., with a mouse, touchscreen, stylus, etc.), the input originating from a bodily motion that can be received, recognized, and translated into a selection and/or movement of an element or object on a graphical user interface that mimics the bodily motion. FIGS. 10 through 12 and the associated descriptions provide a discussion of a variety of operating environments in which embodiments of the invention may be practiced. However, the devices and systems illustrated and discussed with respect to FIGS. 10 through 12 are for purposes of example and illustration and are not limiting of a vast number of computing device configurations that may be utilized for practicing embodiments of the invention, described herein.

FIG. 10 is a block diagram illustrating example physical components (i.e., hardware) of a computing device 1000 with which embodiments of the invention may be practiced. The computing device components described below may be suitable for the computing devices described above. In a basic configuration, the computing device 1000 may include at least one processing unit 1002 and a system memory 1004. Depending on the configuration and type of computing device, the system memory 1004 may comprise, but is not limited to, volatile storage (e.g., random access memory), non-volatile storage (e.g., read-only memory), flash memory, or any combination of such memories. The system memory 1004 may include an operating system 1005 and one or more program modules 1006 suitable for running software applications 1020 such as a visual help UI application 1050. The operating system 1005, for example, may be suitable for controlling the operation of the computing device 1000. Furthermore, embodiments of the invention may be practiced in conjunction with a graphics library, other operating systems, or any other application program and is not limited to any particular application or system. This basic configuration is illustrated in FIG. 10 by those components within a dashed line 1008. The computing device 1300 may have additional features or functionality. For example, the computing device 1000 may also include additional data storage devices (removable and/or non-removable) such as, for example, magnetic disks, optical disks, or tape. Such additional storage is illustrated in FIG. 10 by a removable storage device 1009 and a non-removable storage device 1010.

As stated above, a number of program modules and data files may be stored in the system memory 1004. While executing on the processing unit 1002, the program modules 1006, such as the visual help UI application 1050 may perform processes including, for example, one or more of the stages of the method 900. The aforementioned process is an example, and the processing unit 1002 may perform other processes. Other program modules that may be used in accordance with embodiments of the present invention may include electronic mail and contacts applications, word processing applications, database applications, slide presentation applications, drawing or computer-aided application programs, etc. Although described herein as being performed by a spreadsheet application 1050, embodiments may apply to any application with tables or grid-structured data.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 10 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the spreadsheet application 1050 may be operated via application-specific logic integrated with other components of the computing device 1000 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The computing device 1000 may also have one or more input device(s) 1012 such as a keyboard, a mouse, a pen, a sound input device, a touch input device, a microphone, a gesture recognition device, etc. The output device(s) 1014 such as a display, speakers, a printer, etc. may also be included. The aforementioned devices are examples and others may be used. The computing device 1000 may include one or more communication connections 1016 allowing communications with other computing devices 1018. Examples of suitable communication connections 1016 include, but are not limited to, RF transmitter, receiver, and/or transceiver circuitry; universal serial bus (USB), parallel, or serial ports, and other connections appropriate for use with the applicable computer readable media.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media and communication media. Computer storage media may include volatile and nonvolatile, removable and non-removable media implemented in any method or technology for storage of information, such as computer readable instructions, data structures, program modules, or other data. The system memory 1004, the removable storage device 1009, and the non-removable storage device 1010 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by the computing device 1000. Any such computer storage media may be part of the computing device 1000.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

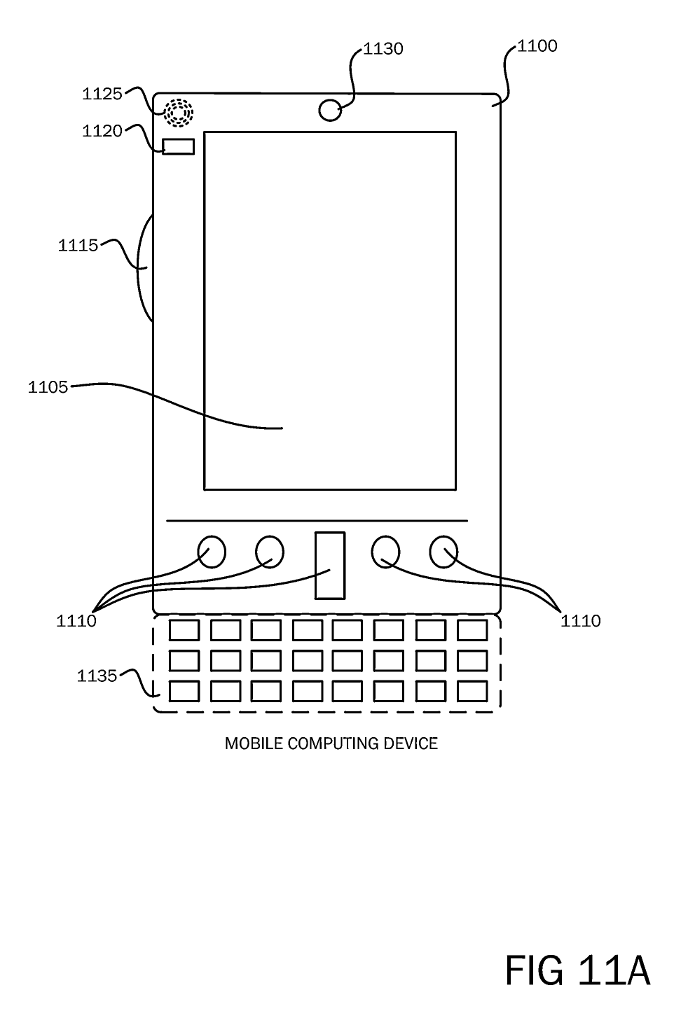

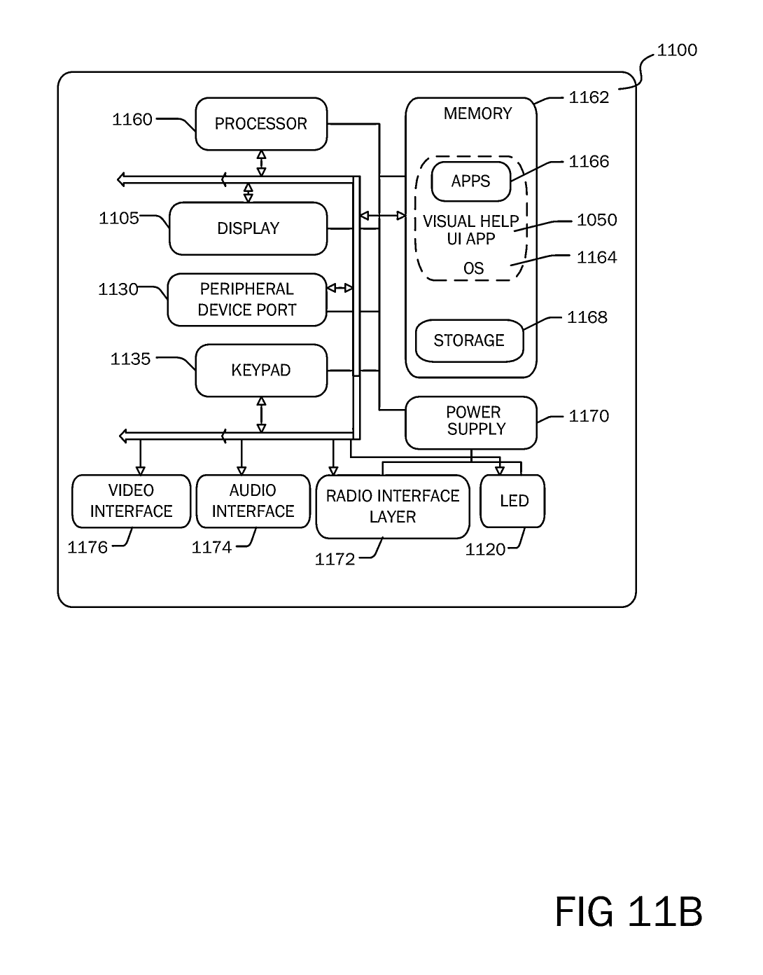

FIGS. 11A and 11B illustrate a mobile computing device 1100, for example, a mobile telephone 200, a smart phone, a tablet personal computer 300, a laptop computer 700, and the like, with which embodiments of the invention may be practiced. With reference to FIG. 11A, an exemplary mobile computing device 1100 for implementing the embodiments is illustrated. In a basic configuration, the mobile computing device 1100 is a handheld computer having both input elements and output elements. The mobile computing device 1100 typically includes a display 1105 and one or more input buttons 1110 that allow the user to enter information into the mobile computing device 1100. The display 1105 of the mobile computing device 1100 may also function as an input device (e.g., a touch screen display). If included, an optional side input element 1115 allows further user input. The side input element 1115 may be a rotary switch, a button, or any other type of manual input element. In alternative embodiments, mobile computing device 1100 may incorporate more or less input elements. For example, the display 1105 may not be a touch screen in some embodiments. In yet another alternative embodiment, the mobile computing device 1100 is a portable phone system, such as a cellular phone. The mobile computing device 1100 may also include an optional keypad 1135. Optional keypad 1135 may be a physical keypad or a “soft” keypad generated on the touch screen display. In various embodiments, the output elements include the display 1105 for showing a graphical user interface (GUI), a visual indicator 1120 (e.g., a light emitting diode), and/or an audio transducer 1125 (e.g., a speaker). In some embodiments, the mobile computing device 1100 incorporates a vibration transducer for providing the user with tactile feedback. In yet another embodiment, the mobile computing device 1100 incorporates input and/or output ports, such as an audio input (e.g., a microphone jack), an audio output (e.g., a headphone jack), and a video output (e.g., a HDMI port) for sending signals to or receiving signals from an external device.

FIG. 11B is a block diagram illustrating the architecture of one embodiment of a mobile computing device. That is, the mobile computing device 1100 can incorporate a system (i.e., an architecture) 1102 to implement some embodiments. In one embodiment, the system 1102 is implemented as a “smart phone” capable of running one or more applications (e.g., browser, e-mail, calendaring, contact managers, messaging clients, games, and media clients/players). In some embodiments, the system 1102 is integrated as a computing device, such as an integrated personal digital assistant (PDA) and wireless phone.

One or more application programs 1166 may be loaded into the memory 1162 and run on or in association with the operating system 1164. Examples of the application programs include phone dialer programs, e-mail programs, personal information management (PIM) programs, word processing programs, spreadsheet programs, Internet browser programs, messaging programs, and so forth. The system 1102 also includes a non-volatile storage area 1168 within the memory 1162. The non-volatile storage area 1168 may be used to store persistent information that should not be lost if the system 1102 is powered down. The application programs 1166 may use and store information in the non-volatile storage area 1168, such as e-mail or other messages used by an e-mail application, and the like. A synchronization application (not shown) also resides on the system 1102 and is programmed to interact with a corresponding synchronization application resident on a host computer to keep the information stored in the non-volatile storage area 1168 synchronized with corresponding information stored at the host computer. As should be appreciated, other applications may be loaded into the memory 1162 and run on the mobile computing device 1100, including the visual help UI application 1050 described herein.

The system 1102 has a power supply 1170, which may be implemented as one or more batteries. The power supply 1170 might further include an external power source, such as an AC adapter or a powered docking cradle that supplements or recharges the batteries. The system 1102 may also include a radio 1172 that performs the function of transmitting and receiving radio frequency communications. The radio 1172 facilitates wireless connectivity between the system 1102 and the “outside world”, via a communications carrier or service provider. Transmissions to and from the radio 1172 are conducted under control of the operating system 1164. In other words, communications received by the radio 1172 may be disseminated to the application programs 1166 via the operating system 1164, and vice versa.

The radio 1172 allows the system 1102 to communicate with other computing devices, such as over a network. The radio 1172 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

This embodiment of the system 1102 provides notifications using the visual indicator 1120 that can be used to provide visual notifications and/or an audio interface 1174 producing audible notifications via the audio transducer 1125. In the illustrated embodiment, the visual indicator 1120 is a light emitting diode (LED) and the audio transducer 1125 is a speaker. These devices may be directly coupled to the power supply 1170 so that when activated, they remain on for a duration dictated by the notification mechanism even though the processor 1160 and other components might shut down for conserving battery power. The LED may be programmed to remain on indefinitely until the user takes action to indicate the powered-on status of the device. The audio interface 1174 is used to provide audible signals to and receive audible signals from the user. For example, in addition to being coupled to the audio transducer 1125, the audio interface 1174 may also be coupled to a microphone 702 to receive audible input, such as to facilitate a telephone conversation. In accordance with embodiments of the present invention, the microphone may also serve as an audio sensor to facilitate control of notifications, as will be described below. The system 1102 may further include a video interface 1176 that enables an operation of an on-board camera 1130 to record still images, video stream, and the like.

A mobile computing device 1100 implementing the system 1102 may have additional features or functionality. For example, the mobile computing device 1100 may also include additional data storage devices (removable and/or non-removable) such as, magnetic disks, optical disks, or tape. Such additional storage is illustrated in FIG. 11B by the non-volatile storage area 1168. Computer storage media may include volatile and nonvolatile, removable and non-removable media implemented in any method or technology for storage of information, such as computer readable instructions, data structures, program modules, or other data.

Data/information generated or captured by the mobile computing device 1100 and stored via the system 1102 may be stored locally on the mobile computing device 1100, as described above, or the data may be stored on any number of storage media that may be accessed by the device via the radio 1172 or via a wired connection between the mobile computing device 1100 and a separate computing device associated with the mobile computing device 1100, for example, a server computer in a distributed computing network, such as the Internet. As should be appreciated such data/information may be accessed via the mobile computing device 1100 via the radio 1172 or via a distributed computing network. Similarly, such data/information may be readily transferred between computing devices for storage and use according to well-known data/information transfer and storage means, including electronic mail and collaborative data/information sharing systems.

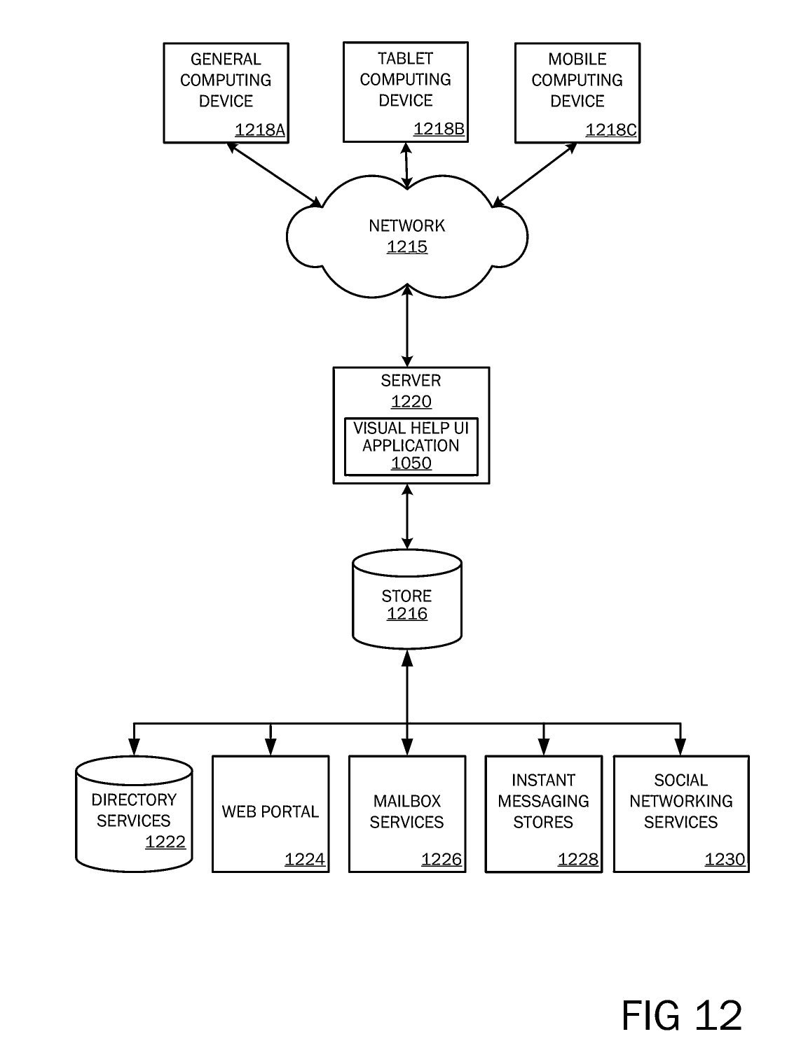

FIG. 12 illustrates one embodiment of the architecture of a system for providing the visual help UI application 1050 to one or more client devices, as described above. Content developed, interacted with or edited in association with the visual help UI application 1050 may be stored in different communication channels or other storage types. For example, various documents may be stored using a directory service 1222, a web portal 1224, a mailbox service 1226, an instant messaging store 1228, or a social networking site 1230. The visual help UI application 1050 may use any of these types of systems or the like for providing a visual guidance user interface for helping a user learn a product's capability and inputs needed to achieve a given action, as described herein. A server 1220 may provide the visual help UI application 1050 to clients. As one example, the server 1220 may be a web server providing the visual help UI application 1050 over the web. The server 1220 may provide the visual help UI application 1050 over the web to clients through a network 1215. By way of example, the client computing device 1218 may be implemented as the computing device 1000 and embodied in a personal computer 1218a, a tablet computing device 1218b and/or a mobile computing device 1218c (e.g., a smart phone). Any of these embodiments of the client computing device 1218 may obtain content from the store 1216. In various embodiments, the types of networks used for communication between the computing devices that make up the present invention include, but are not limited to, an internet, an intranet, wide area networks (WAN), local area networks (LAN), and virtual private networks (VPN). In the present application, the networks include the enterprise network and the network through which the client computing device accesses the enterprise network (i.e., the client network). In one embodiment, the client network is part of the enterprise network. In another embodiment, the client network is a separate network accessing the enterprise network through externally available entry points, such as a gateway, a remote access protocol, or a public or private internet address.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the claimed invention and the general inventive concept embodied in this application that do not depart from the broader scope.

We claim:

1. A method for providing a visual guidance user interface for helping a user learn a product's capability and inputs needed to achieve a given action, the method comprising:
receiving an input associated with an open application;
determining whether the input meets a criterion for triggering a visual help user interface; and
in response to determining that the input meets a criterion for triggering a visual help user interface, displaying the visual help user interface over a graphical user interface of the open application.

2. The method of claim 1, wherein determining that the input meets a criterion for triggering a visual help user interface includes detecting one of: a user needs help discovering a feature to achieve a given action associated with the application, the user needs help discovering a work flow to achieve a given action associated with the application, or the user needs help learning a gesture to achieve a given action associated with the application.

3. The method of claim 1, wherein receiving an input includes sensing an activity affecting achieving a given action associated with the application, receiving a command sequence associated with the given action, or receiving a user request for help.

4. The method of claim 3, wherein sensing an activity affecting achieving a given action associated with the application includes sensing an activity detectible by one of a digitizer, gyroscope, compass, accelerometer, microphone, accelerometer, microphone, light sensor, proximity sensor, near field communications sensor, or GPS.

5. The method of claim 4, further comprising determining inputs needed to achieve the given action associated with the sensed activity.

6. The method of claim 1, wherein displaying the visual help user interface over a graphical user interface of the open application includes demonstrating inputs needed to achieve the given action associated with the sensed activity.

7. The method of claim 1, wherein displaying the visual help user interface over a graphical user interface of the open application includes one of displaying an arrow, a focus indicator, a ghosted hand, a finger, a stylus, an animated figure or avatar, highlighting, audio, or an indication of a touch or a selection.

8. The method of claim 7, wherein displaying the visual help user interface includes demonstrating a gesture, the gesture interacting with content in the application graphical user interface.

9. The method of claim 7, wherein displaying the visual help user interface includes demonstrating a suggested workflow using a user's content in the application graphical user interface.

10. The method of claim 7, wherein displaying the visual help user interface includes demonstrating selecting a functionality associated with the application.

11. A system for providing a visual guidance user interface for helping a user learn a product's capability and inputs needed to achieve a given action, the system comprising:
a memory storage; and
a processing unit coupled to the memory storage, wherein the processing unit is operable to:
receive an input associated with an open application;
determine whether the input meets a criterion for triggering a visual help user interface; and
in response to determining that the input meets a criterion for triggering a visual help user interface, display the visual help user interface over a graphical user interface of the open application, the visual help user interface demonstrating one of:
a feature to achieve a given action associated with the application;
a work flow to achieve a given action associated with the application; or
a gesture to achieve a given action associated with the application.

12. The system of claim 11, wherein being operative to receive an input includes being operative to:
sense an activity affecting achieving a given action associated with the application;
receive a command sequence associated with the given action; or
receive a user request for help.

13. The system of claim 12, further comprising one or more of a digitizer, gyroscope, compass, accelerometer, microphone, accelerometer, microphone, light sensor, proximity sensor, near field communications sensor, or GPS operable to sense an activity affecting achieving a given action associated with the application.

14. The system of claim 13, wherein the processor is further operable to determine inputs needed to achieve the given action associated with the sensed activity.

15. The system of claim 14, wherein the processor is further operable to display the visual help user interface over a graphical user interface of the open application, the visual help user interface demonstrating inputs needed to achieve the given action associated with the sensed activity.

16. The system of claim 11, wherein the visual help user interface includes one of a displaying of an arrow, a focus indicator, a ghosted hand, a finger, a stylus, an animated figure or avatar, highlighting, or an indication of a touch or a selection.

17. The system of claim 11, wherein the visual help user interface includes a demonstration of a suggested workflow using a user's content in the application graphical user interface.

18. The system of claim 11, wherein the visual help user interface includes a demonstration of a gesture, the gesture interacting with a user's content in the application graphical user interface.

19. A computer-readable medium having computer-executable instructions for providing a visual guidance user interface for helping a user learn a product's capability and inputs needed to achieve a given action, comprising:
receiving an input associated with an open application, the input including one of an activity affecting achieving a given action associated with the application, a command sequence associated with the given action, or a user request for help;
determining whether the input meets a criterion for triggering a visual help user interface; and
in response to determining that the input meets a criterion for triggering a visual help user interface, displaying the visual help user interface over a graphical user interface of the open application, the visual help user interface demonstrating one of:
a feature to achieve a given action associated with the application;
a work flow to achieve a given action associated with the application; or
a gesture to achieve a given action associated with the application.

20. The computer-readable medium of claim 19, further comprising:
determining whether the input meets a criterion for triggering a visual help user interface includes determining inputs needed to achieve the given action associated with the sensed activity; and
in response to determining inputs needed to achieve the given action associated with the sensed activity, displaying a visual help user interface demonstrating the inputs needed to achieve the given action associated with the sensed activity.
